(19) United States
(12) Patent Application Publication
(10) Pub. No.: US 2026/0221104 A1
(43) Pub. Date: Jul. 30, 2026

(54) SCAN DRIVING CIRCUIT INCLUDING SHARED LOGIC CIRCUIT, AND ELECTRONIC DEVICE

(71) Applicant: SAMSUNG DISPLAY CO., LTD., YONGIN-SI (KR)

(72) Inventors: JAEKEUN LIM, Yongin-si (KR); HAE-KWAN SEO, Yongin-si (KR)

(21) Appl. No.: 19/389,325

(22) Filed: Nov. 14, 2025

(30) Foreign Application Priority Data
Jan. 24, 2025 (KR) 10-2025-0011260

(51) Int. Cl. G09G 3/3266; G09G 3/3233

(52) U.S. Cl. CPC G09G 3/3266; G09G 3/3233; G09G 2300/0819; G09G 2300/0842; G09G 2300/0861; G09G 2310/027; G09G 2310/0286; G09G 2310/0289; G09G 2310/0291; G09G 2330/023

(57) ABSTRACT

A scan driving circuit of an electronic device includes a logic circuit configured to output a first logic signal and a second logic signal, in response to a start signal and a plurality of logic clock signals, a first buffer configured to output a first scan signal, in response to a first clock signal, the first logic signal, and the second logic signal, and a second buffer configured to output a second scan signal, in response to a second clock signal, the first logic signal, and the second logic signal. Each of the first clock signal and the second clock signals has an amplitude smaller than an amplitude of each of the logic clock signals. The logic circuit is commonly connected to the first buffer and the second buffer.

### CROSS-REFERENCE TO RELATED APPLICATIONS

This application claims priority under 35 U.S.C. § 119 to Korean Patent Application No. 10-2025-0011260, filed on January 24, 2025, the disclosure of which is incorporated by reference herein in its entirety.

### TECHNICAL FIELD

Embodiments of the present disclosure relate to an electronic device.

### DISCUSSION OF RELATED ART

Electronic devices such as televisions (TVs), cellular phones, tablet computers, navigation systems, and portable game consoles display images to users via a display screen.

These devices include a plurality of pixels, as well as driving circuits that control the pixels to display the image. Among these circuits, a scan driving circuit generates scan signals used to drive the pixels.

### SUMMARY

Embodiments of the present disclosure provide a scan driving circuit having reduced power consumption, and an electronic device including the same.

According to an embodiment of the present disclosure, a scan driving circuit includes a logic circuit configured to output a first logic signal and a second logic signal, in response to a start signal and a plurality of logic clock signals, a first buffer to output a first scan signal, in response to a first clock signal, the first logic signal which is received from the logic circuit, and the second logic signal which is received from the logic circuit, and a second buffer configured to output a second scan signal, in response to a second clock signal, the first logic signal which is received from the logic circuit, and the second logic signal which is received from the logic circuit. Each of the first clock signal and the second clock signal has an amplitude smaller than an amplitude of each of the logic clock signals. The logic circuit is commonly connected to the first buffer and the second buffer.

In an embodiment, the first buffer includes a first transistor connected between a first voltage input terminal and a scan output terminal and configured to output the first scan signal. The first transistor includes a gate electrode and is configured to receive the first logic signal. The first buffer further includes a second transistor connected between a first node and a second node. The second transistor includes a gate electrode connected to a second voltage input terminal. The first buffer further includes a third transistor connected between the first scan output terminal and a first clock input terminal and configured to receive the first scan signal. The third transistor includes a gate electrode connected to the second node, and a capacitor connected between the second node and the scan output terminal.

In an embodiment, the second buffer includes a first transistor connected between a first voltage input terminal and a scan output terminal and configured to output the second scan signal. The first transistor includes a gate electrode and is configured to receive the first logic signal. The second buffer further includes a second transistor connected between a first node and a second node. The second transistor includes a gate electrode connected to a second voltage input terminal. The second buffer further includes a third transistor connected between the scan output terminal and a clock input terminal and configured to receive the second scan signal. The third transistor includes a gate electrode connected to the second node, and a capacitor connected between the second node and the scan output terminal.

In an embodiment, the first scan signal and the second scan signal are sequentially changed from an inactive level to an active level, when the first clock signal and the second clock signal are sequentially changed from the inactive level to the active level.

In an embodiment, the first buffer outputs the first scan signal corresponding to the first clock signal, when the second logic signal is at an active level, and the second buffer outputs the second scan signal corresponding to the second clock signal, when the second logic signal is at the active level.

In an embodiment, the first buffer outputs the first scan signal at the inactive level, when the first logic signal is at an active level, and the second buffer outputs the second scan signal at the inactive level, when the first logic signal is at the active level.

In an embodiment, the scan driving circuit further includes a third buffer configured to output a third scan signal in response to the third clock signal, the first logic signal, and the second logic signal, and a fourth buffer configured to output a fourth scan signal, in response to the fourth clock signal, the first logic signal, and the second logic signal.

In an embodiment, the first scan signal, the second scan signal, the third scan signal, and the fourth scan signal are sequentially changed from an inactive level to an active level, when the first clock signal, the second clock signal, the third clock signal, and the fourth clock signal are sequentially changed from the inactive level to the active level.

According to an embodiment of the present disclosure, an electronic device includes a display panel including a first pixel and a second pixel, and a scan driving circuit configured to provide a first scan signal to the first pixel and a second scan signal to the second pixel, in response to a start signal, a plurality of logic clock signals, a first clock signal, and a second clock signal. The scan driving circuit includes a logic circuit configured to output a first logic signal and a second logic signal, in response to the start signal and the logic clock signals, a first buffer configured to output a first scan signal, in response to the first clock signal, the first logic signal which is received from the logic circuit, and the second logic signal which is received from the logic circuit, and a second buffer configured to output a second scan signal, in response to the second clock signal, the first logic signal which is received from the logic circuit, and the second logic signal which is received from the logic circuit. Each of the first clock signal and the second clock signal has an amplitude smaller than an amplitude of each of the logic clock signals. The logic circuit is commonly connected to the first buffer and the second buffer

In embodiment, the first buffer includes a first transistor connected between a first voltage input terminal and a scan output terminal and configured to output the first scan signal. The first transistor includes a gate electrode and is configured to receive the first logic signal. The first buffer further includes a second transistor connected between a first node and a second node. The second transistor includes a gate electrode connected to a second voltage input terminal. The first buffer further includes a third transistor connected between the first scan output terminal and a first clock input terminal and configured to receive the first scan signal. The third transistor includes a gate electrode connected to the second node, and a capacitor connected between the second node and the scan output terminal.

In an embodiment, the second buffer includes a first transistor connected between a first voltage input terminal and a scan output terminal and configured to output the second scan signal. The first transistor includes a gate electrode and is configured to receive the first logic signal. The second buffer further includes a second transistor connected between a first node and a second node. The second transistor includes a gate electrode connected to a second voltage input terminal. The second buffer further includes a third transistor connected between the scan output terminal and a second clock input terminal and configured to receive the second scan signal. The third transistor includes a gate electrode connected to the second node, and a capacitor connected between the second node and the scan output terminal.

In an embodiment, the electronic device further includes a driving controller configured to provide the start signal, the logic clock signals, the first clock signal, and the second clock signal.

In an embodiment, the first scan signal and the second scan signal are sequentially changed from an inactive level to an active level, when the first clock signal and the second clock signal are sequentially changed from the inactive level to the active level.

In an embodiment, the first buffer outputs the first scan signal corresponding to the first clock signal, when the second logic signal is at an active level, and the second buffer outputs the second scan signal corresponding to the second clock signal, when the second logic signal is at the active level.

In an embodiment, the first buffer outputs the first scan signal at the inactive level, when the first logic signal is at an active level, and the second buffer outputs the second scan signal at the inactive level, when the first logic signal is at the active level.

In an embodiment, the data line is commonly connected to the first pixel and the second pixel, and the first scan signal and the second scan signal are sequentially changed from an inactive level to an active level.

In an embodiment, the first pixel and the second pixel are sequentially disposed in the first row.

In an embodiment, the display panel further includes a third pixel and a fourth pixel disposed in a second row, and the second driving circuit further includes a third buffer configured to output the third scan signal in response to the third clock signal, the first logic signal, and the second logic signal, and a fourth buffer configured to output the fourth scan signal, in response to the fourth clock signal, the first logic signal, and the second logic signal.

According to an embodiment of the present disclosure, an electronic device includes a processor to output an image signal and a control signal, and a display module configured to display an image in response to the image signal and the control signal. The display module includes a display panel including ding a first pixel and a second pixel, a driving controller configured to output a scan control signal, in response to the image signal and the control signal, and a scan driving circuit configured to provide the first scan signal to the first pixel and a second scan signal to the second pixel. The scan control signal includes a start signal, a plurality of logic clock signals, a first clock signal, and a second clock signal. The scan driving circuit includes a logic circuit configured to output a first logic signal and a second logic signal, in response to the start signal and the logic clock signals, a first buffer configured to output the first scan signal, in response to the first clock signal, the first logic signal which is received from the logic circuit, and the second logic signal which is received from the logic circuit, and a second buffer configured to output the second scan signal, in response to the second clock signal, the first logic signal which is received from the logic circuit, and the second logic signal which is received from the logic circuit. Each of the first clock signal and the second clock signal has an amplitude smaller than an amplitude of each of the logic clock signals. The logic circuit is commonly connected to the first buffer and the second buffer.

In an embodiment, the first scan signal and the second scan signal are sequentially changed from an inactive level to an active level, when the first clock signal and the second clock signal are sequentially changed from the inactive level to the active level.

### BRIEF DESCRIPTION OF THE DRAWINGS

The above and other objects and features of the present disclosure will become more apparent by describing in detail embodiments thereof with reference to the accompanying drawings.

FIG. 1 is a block diagram illustrating an electronic device according to an embodiment of the present disclosure.

FIG. 2 illustrates schematic views of an electronic device according to various embodiments of the present disclosure.

FIG. 3 is a block diagram illustrating a display module according to an embodiment of the present disclosure.

FIG. 4 is a circuit diagram illustrating a first pixel and a second pixel according to an embodiment of the present disclosure.

FIG. 5 is a timing diagram illustrating a first scan signal and a second scan signal.

FIG. 6 is a block diagram illustrating a scan driving circuit illustrated in FIG. 3.

FIG. 7 is a block diagram partially illustrating a logic circuit, a first output buffer, and a second output buffer illustrated in FIG. 6.

FIG. 8 is a circuit diagram illustrating a first logic circuit, first buffers, and second buffers according to an embodiment of the present disclosure.

FIG. 9 is a timing diagram illustrating operations of the first logic, the first buffers, and the second buffers illustrated in FIG. 8.

FIG. 10 is a timing diagram illustrating an operation of a scan driving circuit illustrated in FIG. 6.

FIG. 11 is a circuit diagram of a first logic circuit, a first buffer, and second buffers according to an embodiment of the present disclosure.

### DETAILED DESCRIPTION

Embodiments of the present disclosure will be described more fully hereinafter with reference to the accompanying drawings. Like reference numerals may refer to like elements throughout the accompanying drawings.

It will be understood that the terms “first,” “second,” “third,” etc. are used herein to distinguish one element from another, and the elements are not limited by these terms. Thus, a “first” element in an embodiment may be described as a “second” element in another embodiment.

It should be understood that descriptions of features or aspects within each embodiment should typically be considered as available for other similar features or aspects in other embodiments, unless the context clearly indicates otherwise.

As used herein, the singular forms “a”, “an” and “the” are intended to include the plural forms as well, unless the context clearly indicates otherwise.

As used herein, the term "and/or" includes any and all combinations of one or more of the associated listed items. Expressions such as “at least one of,” when preceding a list of elements, modify the entire list of elements and do not modify the individual elements of the list.

Spatially relative terms, such as “beneath”, “below”, “lower”, “under”, “above”, “upper”, etc., may be used herein for ease of description to describe one element or feature’s relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below.

It will be understood that when a component is referred to as being “on”, “connected to”, “coupled to”, or “adjacent to” another component, it can be directly on, connected, coupled, or adjacent to the other component, or intervening components may be present. It will also be understood that when a component is referred to as being “between” two components, it can be the only component between the two components, or one or more intervening components may also be present. Other words used to describe the relationships between components should be interpreted in a like fashion.

Herein, when two or more elements or values are described as being substantially the same as or about equal to each other, it is to be understood that the elements or values are identical to each other, the elements or values are equal to each other within a measurement error, or if measurably unequal, are close enough in value to be functionally equal to each other as would be understood by a person having ordinary skill in the art. For example, the term “about” as used herein is inclusive of the stated value and means within an acceptable range of deviation for the particular value as determined by one of ordinary skill in the art, considering the measurement in question and the error associated with measurement of the particular quantity (e.g., the limitations of the measurement system). For example, “about” may mean within one or more standard deviations as understood by one of the ordinary skill in the art, for example, within ± 30%, 20%, 10% or 5% of the stated value. Further, it is to be understood that while parameters may be described herein as having “about” a certain value, according to embodiments, the parameter may be exactly the certain value or approximately the certain value within a measurement error as would be understood by a person having ordinary skill in the art. Other uses of these terms and similar terms to describe the relationships between components should be interpreted in a like fashion.

It will be further understood that the terms “comprise,” “include,” or “including,” or “have” or “having” specify the presence of stated features, numbers, steps, operations, components, parts, or the combination thereof, but do not preclude the presence or addition of one or more other features, numbers, steps, operations, components, components, and/or the combination thereof.

Embodiments of the present disclosure relate to a scan driving circuit used to control pixel operation in a display device. For example, embodiments provide a scan driving circuit including a logic circuit and associated output buffers configured to reduce power consumption during pixel control by controlling signal swing characteristics at various stages of the scan driving process.

Referring to a display device according to a comparative example, scan driving circuits may operate using multiple clock signals to generate scan signals for controlling pixel elements. These clock signals often swing across a wide voltage range, which may increase overall power consumption. In contrast, a scan driving circuit according to embodiments of the present disclosure is configured to generate logic signals using a logic circuit that receives a start signal and multiple logic clock signals. These logic signals may then be used by a first buffer and a second buffer to generate corresponding scan signals in response to respective clock signals.

In an embodiment, the clock signals used by the output buffers (e.g., the first and second clock signals) may be configured to have a smaller amplitude than the logic clock signals used by the logic circuit. This signal configuration may allow for driving pixel scan lines with reduced voltage swings, which may lower the dynamic power consumption of the overall circuit. This structure may contribute to improved power efficiency, especially in high-resolution display devices where a large number of pixels and scan lines are driven.

In addition, the scan driving circuit according to embodiments may be configured such that the logic circuit is commonly connected to both the first and second output buffers. This shared configuration may enable synchronized control over multiple scan outputs while simplifying circuit layout and reducing redundancy. The combination of logic signal generation, reduced-swing buffer operation, and signal timing coordination provided by embodiments of the present disclosure may contribute to improved performance and energy efficiency in display applications.

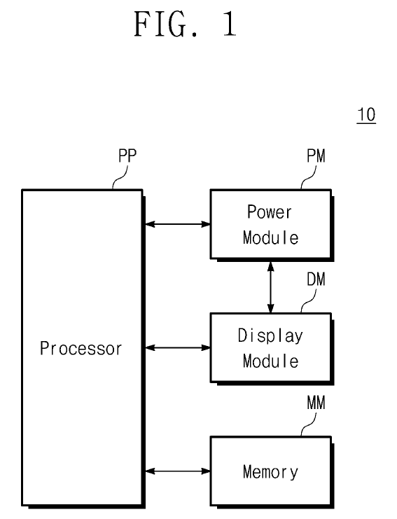

FIG. 1 is a block diagram of an electronic device 10 according to an embodiment.

Referring to FIG. 1, the electronic device 10 according to an embodiment may include a display module DM, a processor PP, a memory MM, and a power module PM.

The processor PC may include at least one of, for example, a central processing unit (CPU), an application processor (AP), a graphic processing unit (GPU), a communication processor (CP), an image signal processor (ISP), or a controller.

The memory MM may store data information used for operation of the processor PP or a display module DM. When the processor PP runs the application stored in the memory MM, an image data signal and/or an input control signal may be transmitted to the display module DM, and the display module DM may process the transmitted signal and output image information through the display screen.

The power module PM may include a power supply module, such as a power adaptor or a battery device, and a power converting module that convert the power supplied from the power supply module into power used for operation of the electronic device 10.

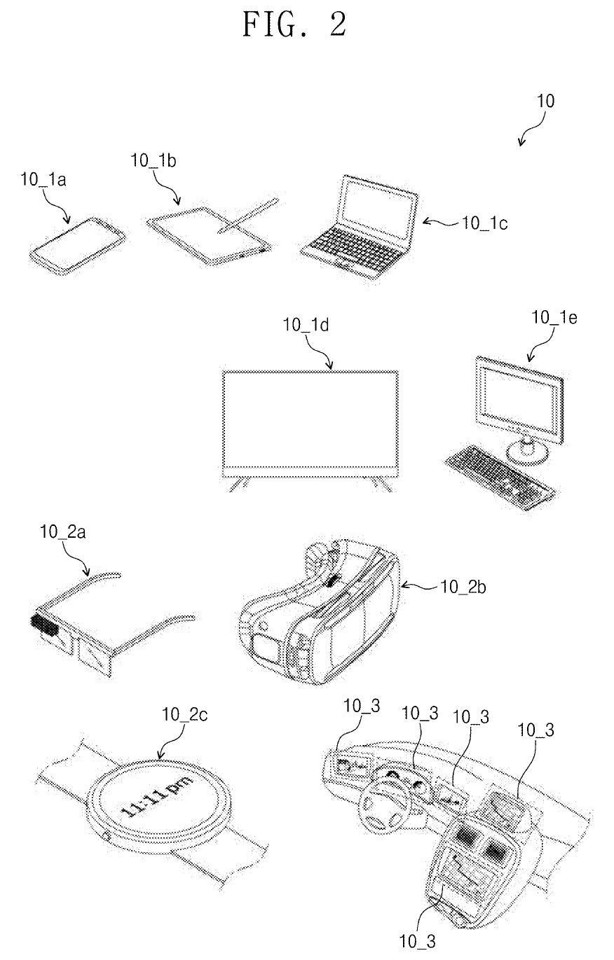

FIG. 2 illustrates schematic views of an electronic device according to various embodiments.

Referring to FIG. 2, various electronic devices according to embodiments may include, for example, a wearable electronic device including a display module such as smart glasses 10_2a, a head mounted display 10_2b, and a smart watch 10_2c, and an electronic device 10-3 for the vehicle including the display module such as a center information display (CID), which is disposed in, e.g., an instrument panel, a centerfecia, and a dashboard of a vehicle, or a room mirror display, as well as an electronic device for image display such as, e.g., a smartphone 10_1a, a tablet PC 10_1b, a laptop computer 10_1c, a television (TV) 10_1d, and a computer monitor 10_1e.

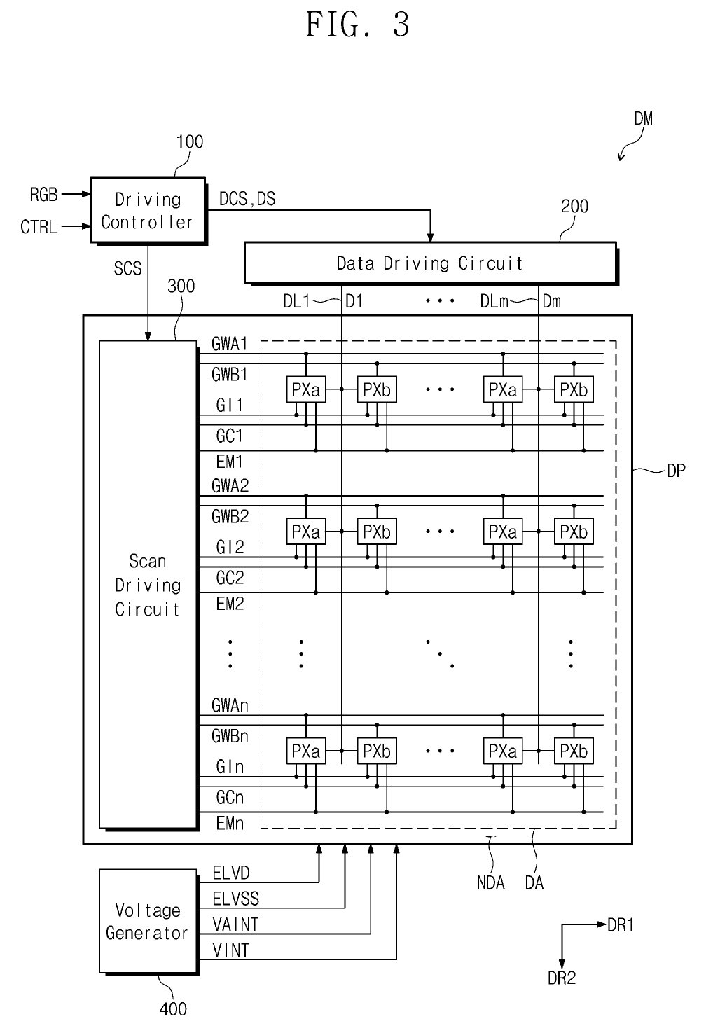

FIG. 3 is a block diagram of the display module DM according to an embodiment.

Referring to FIG. 3, the display module DM includes a display panel DP, a driving controller 100, a data driving circuit 200, a scan driving circuit 300, and a voltage generator 400 (also referred to as a voltage generator circuit).

The display panel DP according to an embodiment of the present disclosure may be an emissive-type display panel. For example, the display panel DP may be an organic light-emitting display panel, an inorganic light-emitting display panel, or a quantum dot light-emitting display panel. A light-emitting layer of the organic light-emitting display panel may include an organic light-emitting material. A light-emitting layer of the inorganic light-emitting display panel may include an inorganic light-emitting material. A light-emitting layer of the quantum dot light-emitting display panel may include a quantum dot and a quantum rod. Hereinafter, the display panel DP according to the an embodiment will be referred to as the organic light-emitting display panel.

The display panel DP includes a plurality of first pixels PXa and a plurality of second pixels PXb.

A data line may be commonly connected to some of the first pixels PXa and some of the second pixels PXb. For example, a data line DL1 is commonly connected to some of the first pixels PXa (for example, the first pixels PXa arranged in a first column) and some of the second pixels PXb (for example, the second pixels PXb arranged in a second column). For example, a data line DLm is commonly connected to some of the first pixels PXa (for example, the first pixels PXa arranged in a (2m-1)-th column) and some of the second pixels PXb (for example, the second pixels PXb arranged in a 2m-th column) . In this case, “m” is a positive integer. According to an embodiment, the first pixels PXa and the second pixels PXb may be alternately arranged one by one in one row.

Each of the first pixels PXa and the second pixels PXb may include a light-emitting element. According to an embodiment, the light-emitting element may be an organic light-emitting element. However, the present disclosure is not limited thereto.

The driving controller 100 receives an input image signal RGB and a control signal CTRL. According to an embodiment, the input image signal RGB and the control signal CTRL may be provided from the processor PP illustrated in FIG. 1.

The driving controller 100 provides a data control signal DCS and an image data signal DS to the data driving circuit 200. The driving controller 100 provides a scan control signal SCS to the scan driving circuit 300.

The data driving circuit 200 receives the data control signal DCS and the image data signal DS from the driving controller 100. The data driving circuit 200 converts the image data signal DS into data signals and then outputs the data signals to data lines DL1 to DLm. The data signals are analog voltages corresponding to the image data signal DS. The data lines DL1 to DLm may be spaced apart from each other in the first direction DR1. The data lines DL1 to DLm may extend in a second direction DR2 crossing the first direction DR1.

The scan driving circuit 300 receives a scan control signal SCS from the driving controller 100. The scan driving circuit 300 outputs first scan signals GWA1 to GWAn, second scan signals GWB1 to GWBn, and scan signals G11 to GIn, GC1 to GCn, and EM1 to EMn, in response to the scan control signal SCS. The first scan signals GWA1 to GWAn, the second scan signals GWB1 to GWBn, and the scan signals G11 to GIn, GC1 to GCn, and EM1 to EMn may be provided to the first pixels PXa and the second pixels PXb. According to an embodiment, the first scan signals GWA1 to GWAn, the second scan signals GWB1 to GWBn, and the scan signals G11 to GIn, GC1 to GCn, and EM1 to EMn may be transmitted to the first pixels PXa and the second pixels PXb through scan lines extending in the first direction DR1 from the scan driving circuit 300.

According to an embodiment, the scan driving circuit 300 may be disposed on the display panel DP. According to an embodiment, the first pixels PXa and the second pixels PXb may be disposed in a display area DA of the display panel DP, and the scan driving circuit 300 may be disposed in a non-display area NDA of the display panel DP. According to an embodiment, the scan driving circuit 300 may be formed through a process the same as a process for the first pixels PXa and the second pixels PXb, but the present disclosure is not limited thereto.

The first pixels PXa and the second pixels PXb, which are disposed in a first row, among the first pixels PXa and the second pixels PXb, operate in response to a first scan signal GWA1, a second scan signal GWB1, and scan signals GI1, GC1, and EM1. For example, the first pixels PXa and the second pixels PXb disposed in the first row may display an image corresponding to the data signals provided through the data lines DL1 to DLm, in response to the first scan signal GWA1, the second scan signal GWB1, and the scan signals GI1, GC1, and EM1.

The first pixels PXa and the second pixels PXb, which are disposed in an n-th row, among the first pixels PXa and the second pixels PXb, operate in response to the first scan signal GWAn, the second scan signal GWBn, and the scan signals GIn, GCn, and EMn. For example, the first pixels PXa and the second pixels PXb, which are disposed in the n-th row, may display the image corresponding to the data signals provided from the data lines DL1 to DLm, in response to the first scan signal GWAn, the second scan signal GWBn, and the scan signals GIn, GCn, and EMn.

The voltage generator 400 generates voltages, such as, for example, a first voltage ELVDD, a second voltage ELVSS, and a third voltage VAINT, and a fourth voltage VINT, which are used for operation of the display panel DP. The number of voltages generated from the voltage generator 400 may be varied.

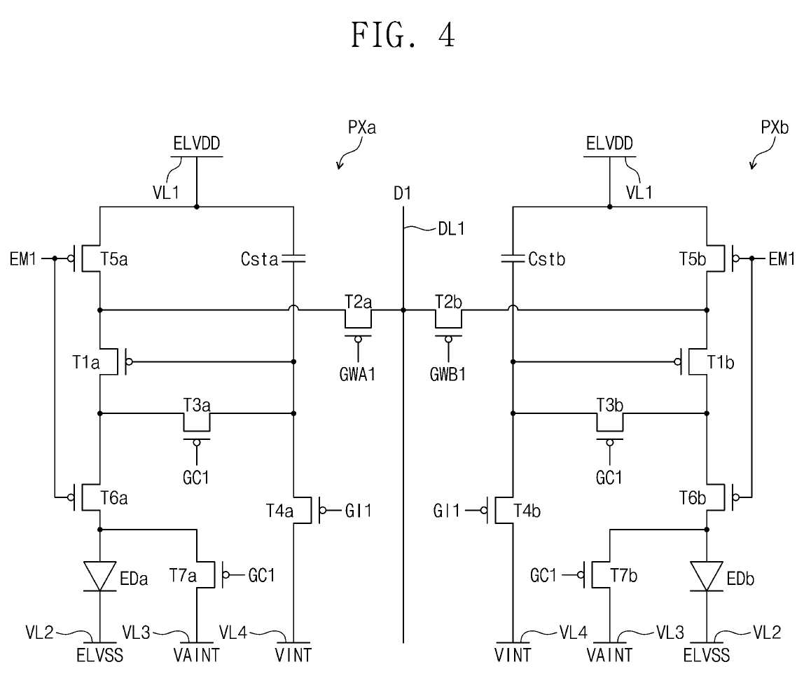

FIG. 4 is a circuit diagram of the first pixel PXa and the second pixel PXb according to an embodiment of the present disclosure.

FIG. 4 illustrates one of the first pixels PXa and one of the second pixels PXb, which are disposed in the first row, among the first pixels PXa and the second pixels PXb illustrated in FIG. 3.

A first data line DL1 among is the data lines DL1 to DLm illustrated in FIG. 1 is commonly connected to the first pixel PXa and the second pixel PXb . The first pixel PXa receives the first scan signal GWA1 and the scan signals GI1, GC1, and EM1. The second pixel PXb receives a second scan signal GWB1 and the scan signals GI1, GC1, and EM1.

The first pixel PXa includes first to seventh transistors T1a, T2a, T3a, T4a, T5a, T6a, and T7a, a capacitor Csta, and at least one light-emitting element EDa. According to an embodiment, the light-emitting element EDa may be a light-emitting diode.

Each of the first to seventh transistors T1a to T7a is a P-type transistor having a low-temperature polycrystalline silicon (LTPS) semiconductor layer. However, the present disclosure is not limited thereto. For example, in an embodiment, at least one of the first to seventh transistors T1a to T7a may be an N-type transistor including a semiconductor layer formed of an oxide semiconductor, and remaining ones of the first to seventh transistors T1a to T7a may be a P-type transistor. According to an embodiment, each of the first to seventh transistors T1a to T7a may be an N-type transistor.

First to fourth voltage lines VL1, VL2, VL3, and VL4 may transmit the first voltage ELVDD, the second voltage ELVSS, the third voltage VAINT, and the fourth voltage VINT, respectively.

The first transistor T1a includes a first electrode connected to the first voltage line VL1 through the fifth transistor T5a, a second electrode electrically connected to an anode of the light-emitting element EDa through the sixth transistor T6a, and a gate electrode connected to a first terminal of the capacitor Cst. The first transistor T1a may receive the data signal D1 received through the data line DL1 depending on the switching operation of the second transistor T2a and supply a driving current to the light-emitting element EDa.

The second transistor T2a includes a first electrode connected to the data line DL1, a second electrode connected to the first electrode of the first transistor T1a, and a gate electrode to receive the first scan signal GWA1. The second transistor T2a may be turned on in response to the first scan signal GWA1 and may transmit the data signal D1, which is received through the data line DL1, to the first electrode of the first transistor T1a.

The third transistor T3a includes a first electrode connected to the gate electrode of the first transistor T1a, a second electrode connected to the second electrode of the first transistor T1a, and a gate electrode to receive the scan signal GC1. The third transistor T3a may be turned on in response to the scan signal GC1 and may connect the gate electrode of the first transistor T1a to the second electrode of the first transistor T1a such that the first transistor T1a is diode-connected.

The fourth transistor T4a includes a first electrode connected to the gate electrode of the first transistor T1a, a second electrode connected to the fourth voltage line VL4 that transmits the fourth voltage VINT, and a gate electrode to receive the scan signal Gl1. The fourth transistor T4a may be turned on in response to the scan signal GI1, and may transmit the fourth voltage VINT to the gate electrode of the first transistor T1a such that an initializing operation is performed to initialize the voltage at the gate electrode of the first transistor T1a.

The fifth transistor T5a includes a first electrode connected to a first electrode of the first voltage line VL1, a second electrode connected to the first electrode of the first transistor T1a, and a gate electrode to receive the scan signal EM1.

The sixth transistor T6a includes a first electrode connected to the second electrode of the first transistor T1a, a second electrode connected to an anode of the light-emitting element EDa, and a gate electrode to receive the scan signal EM1.

The fifth transistor T5a and the sixth transistor T6a may be simultaneously turned on in response to the scan signal EM1. Accordingly, the first voltage ELVDD may be compensated through the first transistor T1a which is diode-connected and transmitted to the light-emitting element EDa.

The seventh transistor T7a includes a first electrode connected to the anode of the light-emitting element EDa, a second electrode connected to the third voltage line VL3, and a gate electrode to receive the scan signal GC1. The seventh transistor T7a is turned on in response to the scan signal GC1 to bypass a current, which is applied to the anode of the light-emitting element EDa, to the third voltage line VL3. According to an embodiment, the seventh transistor T7a may receive the scan signal GI1 instead of the scan signal GC1.

A first terminal of the capacitor Csta is connected to the gate electrode of the first transistor T1a, and a second terminal of the capacitor Csta is connected to the first voltage line VL1. The anode of the light-emitting element EDa may be connected to the second electrode of the sixth transistor T6a, and the cathode of the light-emitting element EDa may be connected to the second voltage line VL2 and may transmit the second voltage ELVSS.

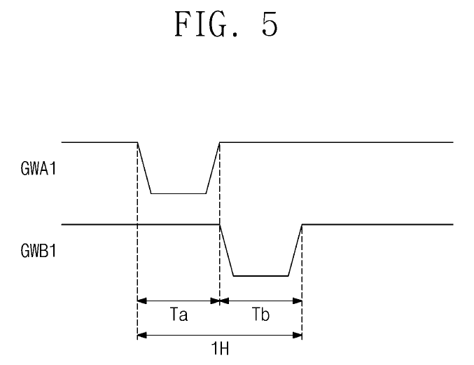

The circuit configuration of the first pixel PXa according to an embodiment is not limited to the circuit configuration illustrated in FIG. 5. For example, according to embodiments, the number of transistors included in the first pixel PXa, the number of capacitors included in the first pixel PXa, and the connection relation between the transistors and the capacitors may be variously modified.

The second pixel PXb includes first to seventh transistors T1b, T2b, T3b, T4b, T5b, T6b, and T7b, a capacitor Cstb, and at least one light-emitting element EDb. According to an embodiment, the circuit configuration and the operation of the second pixel PXb are similar to the circuit configuration and the operation of the first pixel PXa. Accordingly, for convenience of explanation, a detailed description thereof will be omitted.

FIG. 5 is a timing diagram illustrating the first scan signal GWA1 and the second scan signal GWB1.

Referring to FIGS. 4 and 5, when the first scan signal GWA1 is at a low level for a first time interval Ta, the second transistor T2a in the first pixel PXa is turned on. As the second transistor T2a in the first pixel PXa is turned on, the data signal D1 received through the data line DL1 is stored in the capacitor Csta through the first, second, and third transistors T1a, T2a, and T3a in the first pixel PXa. Accordingly, the light-emitting element EDa in the first pixel PXa may emit light with a luminance corresponding to the data signal D1 stored in the capacitor Csta.

When the second scan signal GWB1 is at a low level for a second time interval Tb, the second transistor T2b in the second pixel PXb is turned on. As the second transistor T2b in the second pixel PXb is turned on, the data signal D1 received through the data line DL1 is stored in the capacitor Cstb through the first, second, and third transistors T1b, T2b, and T3b in the second pixel PXb. Accordingly, the light-emitting element EDb in the second pixel PXb may emit light with a luminance corresponding to the data signal D1 stored in the capacitor Cstb.

As the first scan signal GWA1 and the second scan signal GWB1 are sequentially shifted to be at a low level for one horizontal period 1H, data signals D1, which are received through the data line DL1, may be sequentially provided to the first pixel PXa and the second pixels PXb. According to an embodiment, the data signals D1, which are provided to the first pixel PXa and the second pixels PXb, respectively, may be the same or different from each other.

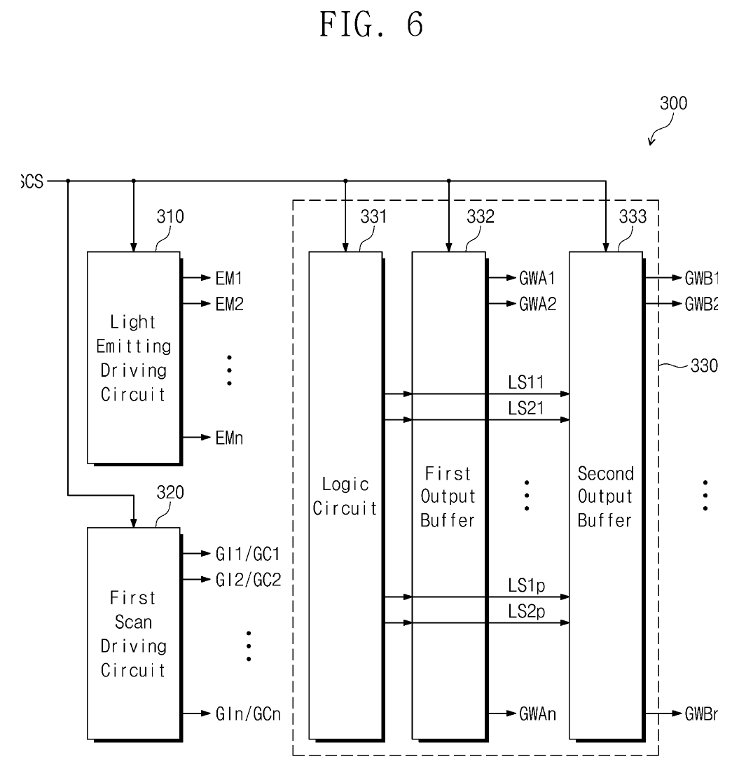

FIG. 6 is a block diagram illustrating the scan driving circuit 300 illustrated in FIG. 3.

Referring to FIG. 6, the scan driving circuit 300 includes a light-emitting driving circuit 310, a first scan driving circuit 320, and a second scan driving circuit 330.

In an embodiment according to FIG. 6, the second scan driving circuit 330 may implement a power-efficient scan signal generation scheme. For example, a logic circuit 331 may generate logic signals (e.g., LS11 to LS1p and LS21 to LS2p) that are reused across both the first output buffer 332 (also referred to as a first buffer) and the second output buffer 333 (also referred to as a second buffer). This configuration may reduce circuit redundancy and reduce overall area. Further, the use of the separate logic signal path may allow the buffers to be driven by clock signals having smaller voltage swing amplitudes than the logic clock signals, which may contribute to a reduction in power consumption of the scan driving circuit 300.

The light-emitting driving circuit 310 outputs the scan signals EM1 to EMn in response to the scan control circuit SCS.

The first scan driving circuit 320 outputs the scan signals GI1 to GIn and GC1 to GCn, in response to the scan control signal SCS. According to an embodiment, the scan signals GI1 to GIn may be the same as the scan signals GC1 to GCn. However, the present disclosure is not limited thereto. For example, in an embodiment, the scan signals GI1 to GIn may be different from the scan signals GC1 to GCn.

The second scan driving circuit 330 includes a logic circuit 331, a first output buffer 332, and a second output buffer 333. The logic circuit 331 outputs first logic signals LS11 to LS1p and second logic signals LS21 to LS2p, in response to the scan control signal SCS. According to an embodiment, ‘p’ may be a positive integer while satisfying p ≥ n/2. The first output buffer 332 outputs the first scan signals GWA1 to GWAn, in response to the scan control signal SCS, the first logic signals LS11 to LS1p, and the second logic signals LS21 to LS2p. The second output buffer 333 outputs the second scan signals GWB1 to GWBn, in response to the scan control signal SCS, the first logic signals LS11 to LS1p, and the second logic signals LS21 to LS2p.

As illustrated in FIG. 6, in an embodiment, the use of the logic circuit 331 to generate logic signals that are shared across both the first output buffer 332 and the second output buffer 333 may enable efficient reuse of drive logic. For example, the logic circuit 331 may be commonly connected to both the first output buffer 332 and the second output buffer 333. This may reduce the number of logic blocks utilized and contribute to a more compact scan driving circuit layout. In addition, since the first and second output buffers 332 and 33 are driven by clock signals that can have a lower voltage swing than the logic clock signals, the system can reduce dynamic power consumption during scan signal transitions, which may improve overall power efficiency of the display module DM.

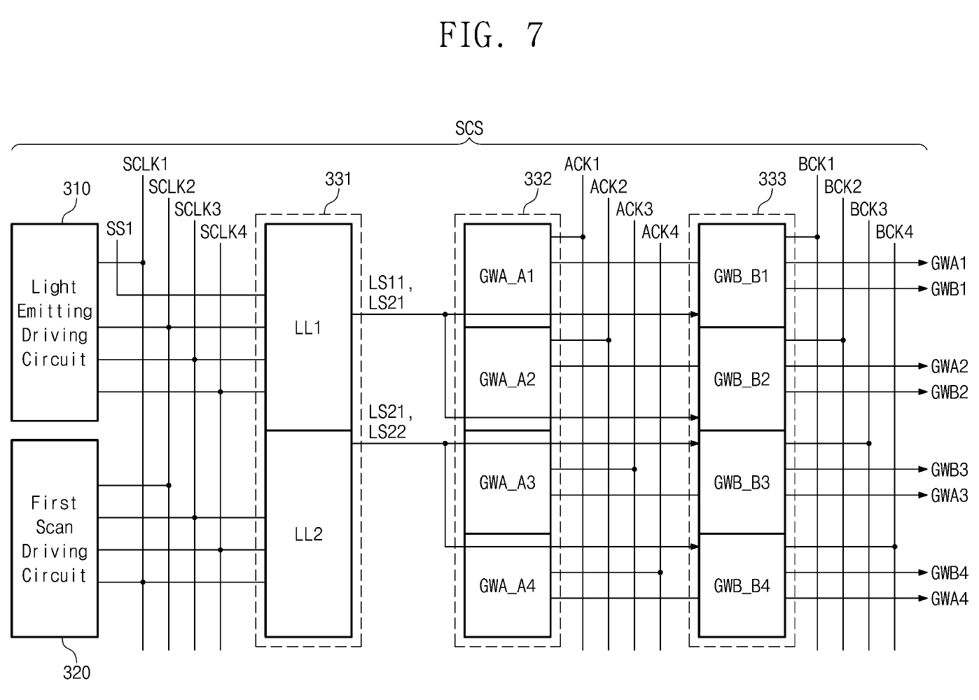

FIG. 7 is a block diagram partially illustrating the logic circuit 331, the first output buffer 332, and the second output buffer 333 illustrated in FIG. 6.

Referring to FIG. 7, the light-emitting driving circuit 310, the first scan driving circuit 320, and the logic circuit 321 operate in response to logic clock signals SCLK2, SCLK3, and SCLK4.

The light-emitting driving circuit 310 may output the scan signals EM1 to EMn (see FIG. 6), in response to the logic clock signals SCLK2, SCLK3, and SCLK4.

The first scan driving circuit 320 may output the scan signals GI1 to GIn and GC1 to GCn (see FIG. 6), in response to the logic clock signals SCLK2, SCLK3, and SCLK4.

The logic circuit 331 includes a first logic circuit LL1 and a second logic circuit LL2. The first logic circuit LL1 outputs first and second logic signals LS11 and LS21, in response to a start signal SS1 and the logic clock signals SCLK2, SCLK3, and SCLK4. The second logic circuit LL2 outputs first and second logic signals LS12 and LS22, in response to a start signal SS1 and the logic clock signals SCLK3, SCLK4, and SCLK1. Although not illustrated in drawings, the second logic circuit LL2 may receive, as a start signal, a carry signal output from the first logic circuit LL1.

In an embodiment according to FIG. 7, the logic circuit 331 may be divided into multiple logic circuits (e.g., LL1, LL2), each of which generates logic signals for a group of scan outputs. The cascading of logic circuits via carry signals may enable sequential activation without requiring complex or large-scale logic duplication. This modular approach may contribute to area efficiency and simplify timing control across a large number of output buffers.

The first output buffer 332 outputs the first scan signals GWA1, GWA2, GWA3, and GWA4, in response to first clock signals AC1, ACK2, ACK3, and ACK4, the first logic signals LS11 and LS21, and the second logic signals LS21 and LS22.

The first output buffer 332 includes first buffers GWA_A1, GWA_A2, GWA_A3, and GWA_A4. The first buffer GWA_A1 outputs the first scan signal GWA1 in response to the first clock signal ACK1, and the first and second logic signals LS11 and LS21. The first buffer GWA_A2 outputs the first scan signal GWA2 in response to the first clock signal ACK2, and the first and second logic signals LS11 and LS21. The first buffer GWA_A3 outputs the first scan signal GWA3 in response to the first clock signal ACK3, and the first and second logic signals LS12 and LS22. The first buffer GWA_A4 outputs the first scan signal GWA4 in response to the first clock signal ACK4, and the first and second logic signals LS12 and LS22.

The second output buffer 333 outputs the second scan signals GWB1, GWB2, GWB3, and GWB4, in response to the second clock signals BCK1, BCK2, BCK3, and BCK4, the first logic signals LS11 and LS21, and the second logic signals LS21 and LS22.

As shown in FIG. 7, in an embodiment, both the first and second output buffers 332 and 323 may reuse common logic signals generated by the upstream logic circuits. Each buffer 332/333 may receive its own dedicated clock signal (e.g., ACK1/ACK2/ACK3/ACK4 or BCK1/BCK2/BCK3/BCK4), but share logic signals (e.g., LS11, LS21, LS12, LS22), allowing multiple scan outputs to be driven without duplicating logic for each. Since the clock signals controlling the buffers swing over a smaller voltage range than the logic clock signals, the system may reduce dynamic power consumption associated with scan signal transitions. This configuration may improve energy efficiency and improve scalability, allowing the configuration to be utilized in high-resolution display applications.

The second output buffer 333 includes second buffers GWB_B1, GWB_B2, GWB_B3, and GWB_B4. The second buffer GWB_B1 outputs the second scan signal GWB1 in response to the second clock signal BCK1, and the first and second logic signals LS11 and LS21. The second buffer GWB_B2 outputs the second scan signal GWB2 in response to the second clock signal BCK2, and the first and second logic signals LS11 and LS21. The second buffer GWB_B3 outputs the second scan signal GWB3 in response to the second clock signal BCK3, and the first and second logic signals LS12 and LS22. The second buffer GWB_B4 outputs the second scan signal GWB4 in response to the second clock signal BCK4, and the first and second logic signals LS12 and LS22.

According to an embodiment, the start signal SS1, the logic clock signals SCLK2, SCLK3, and SCLK4, the first clock signals ACK1, ACK2, ACK3, and ACK4, and the second clock signals BCK1, BCK2, BCK3, and BCK4 may be signals included in the scan control signal SCS.

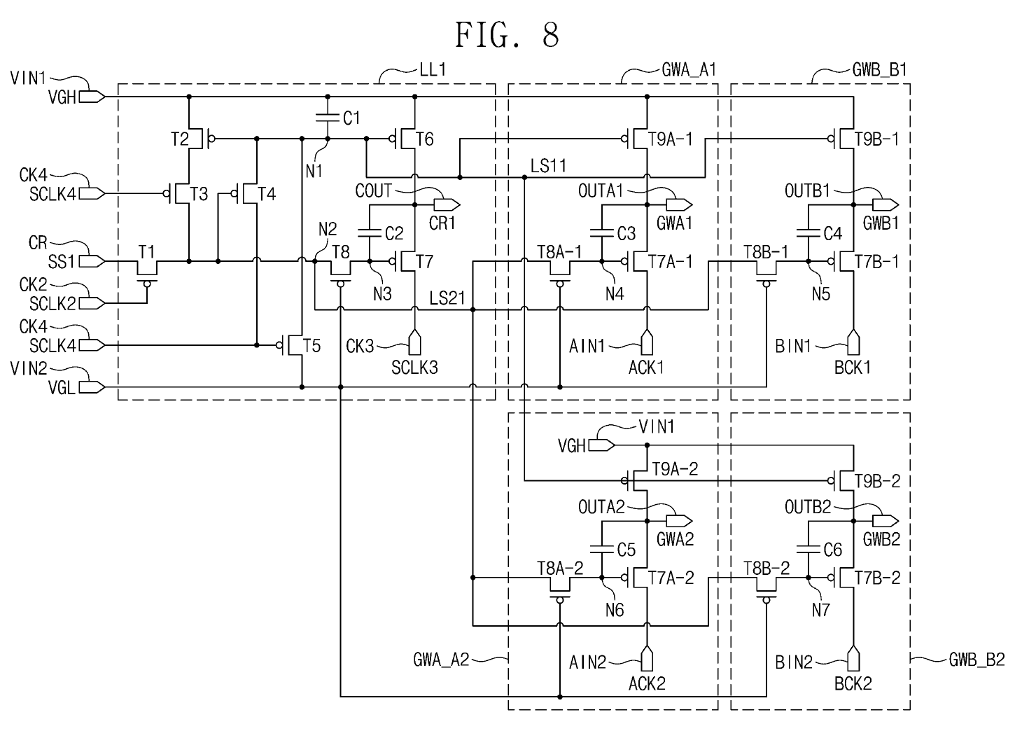

FIG. 8 is a circuit diagram of the first logic circuit LL1, the first buffers GWA_A1 and GWA_A2, and the second buffers GWB_B1 and GWB_B2 according to an embodiment of the present disclosure.

Embodiments of the present disclosure are not limited to the circuit configuration of the first logic circuit LL1, the first buffers GWA_A1 and GWA_A2, and the second buffers GWB_B1 and GWB_B2 illustrated in FIG. 8.

Referring to FIG. 8, the first logic circuit LL1 receives a high voltage VGH, a low voltage VGL, the start signal SS1, and the logic clock signals SCLK2, SCLK3, and SCLK4, and outputs the first and second logic signals LS11 and LS21 to the first node N1 and the second node N2, respectively. The first buffer GWA_A1 receives the high voltage VGH, the low voltage VGL, the first and second logic signals LS11 and LS21, and the first clock signal ACK1, and outputs the first scan signal GWA1. The second buffer GWB_B1 receives the high voltage VGH, the low voltage VGL, the first and second logic signals LS11 and LS21, and the second clock signal BCK1, and outputs the second scan signal GWB1. The first buffer GWA_A2 receives the high voltage VGH, the low voltage VGL, the first and second logic signals LS11 and LS21, and the first clock signal ACK2, and outputs the first scan signal GWA2. The second buffer GWB_B2 receives the high voltage VGH, the low voltage VGL, the first and second logic signals LS11 and LS21, and the second clock signal BCK2, and outputs the second scan signal GWB2.

As shown in FIG. 8, in an embodiment, the scan signal outputs GWA1, GWA2, GWB1, and GWB2 may be generated by buffers that reuse the same logic signals LS11 and LS21, while receiving distinct scan clock signals (e.g., ACK1, BCK1, ACK2, BCK2). Because the first logic circuit LL1 generates logic signals shared by multiple output buffers, embodiments may avoid duplication of logic for each buffer, which may reduce the circuit area. Further, since the clock signals driving the buffers can have a lower voltage swing than the logic clock signals (e.g., about 5.2 V to about -4 V instead of about -8 V), dynamic power consumption during scan signal transitions can be reduced, which may improve the power efficiency of the scan driving circuit 300.

According to an embodiment, the first scan signal GWA1 and the second scan signal GWB1 may be provided to the first pixel PXa and the second pixels PXb, which are disposed in the same row, respectively, as illustrated in FIG. 3.

According to an embodiment, the first scan signal GWA1 and the first scan signal GWA2 may be provided to the first pixels disposed in mutually different rows, respectively, as illustrated in FIG. 3. For example, the first scan signal GWA1 may be provided to the first pixel PXa disposed in the first row, and the first scan signal GWA2 may be provided to the first pixel PXa disposed in the second row.

According to an embodiment, the first scan signal GWB1 and the second scan signal GWB2 may be provided to the second pixels disposed in mutually different rows, respectively, as illustrated in FIG. 3. For example, the second scan signal GWB1 may be provided to the second pixel PXb disposed in the first row, and the second scan signal GWB2 may be provided to the second pixel PXb disposed in the second row.

The first logic circuit LL1 includes transistors T1, T2, T3, T4, T5, T6, T7, and T8 and capacitors C1 and C2. The transistor T1 is connected between a carry input terminal CR and the second node N2, and includes a gate electrode connected to the logic clock terminal CK2. The transistors T2 and T3 are sequentially connected in series between a first voltage input terminal VIN1 and the second node N2. A gate electrode of the transistor T2 is connected to the first node N1, and a gate electrode of the transistor T3 is connected to the logic clock terminal CK4. The transistor T4 is connected between the first node N1 and the logic clock terminal CK4, and includes a gate electrode connected to the second node N2. The transistor T5 is connected between the first node N1 and a second voltage input terminal VIN2, and includes a gate electrode connected to the logic clock terminal CK4. The transistor T6 is connected between the first voltage input terminal VIN1 and the carry output terminal COUT, and includes a gate electrode connected to the first node N1. The transistor T7 is connected between the carry output terminal COUT and the logic clock terminal CK3, and includes a gate electrode connected to the third node N3. The transistor T8 is connected between the second node N2 and a third node N3, and includes a gate electrode connected to the second voltage input terminal VIN2. The capacitor C1 is connected between the first voltage input terminal VIN1 and the first node N1. The capacitor C2 is connected between the carry output terminal COUT and the third node N3.

The carry input terminal CR receives the start signal SS1. The logic clock terminals CK2, CK3, and CK4 receive the logic clock signals SCLK2, SCLK3, and SCLK4. The voltage input terminals VIN1 and VIN2 receive the high voltage VGH and the low voltage VGL, respectively.

The first buffer GWA_A1 includes transistors T7A-1, T8A-1, and T9A-1 and a capacitor C3. The transistor T7A-1 is connected between a scan output terminal OUTA1 and the first clock input terminal AIN1, and includes a gate electrode connected to a fourth node N4. The transistor T8A-1 is connected between the second node N2 and a fourth node N4, and includes a gate electrode connected to the second voltage input terminal VIN2. The transistor T9A-1 is connected between the first voltage input terminal VIN1 and the scan output terminal OUTA1, and includes a gate electrode connected to the first node N1. The capacitor C3 is connected between the fourth node N4 and the scan output terminal OUTA1.

The second buffer GWB_B1 includes transistors T7B-1, T8B-1, and T9B-1 and a capacitor C4. The transistor T7B-1 is connected between a scan output terminal OUTB1 and a second clock input terminal BIN1, and includes a gate electrode connected to a fifth node N5. The transistor T8B-1 is connected between the second node N2 and the fifth node N5 and includes a gate electrode connected to the second voltage input terminal VIN2. The transistor T9B-1 is connected between the first voltage input terminal VIN1 and the scan output terminal OUTB1 and includes a gate electrode connected to the first node N1. The capacitor C4 is connected between the fifth node N5 and the scan output terminal OUTB1.

The first buffer GWA_A2 includes transistors T7A-2, T8A-2, and T9A-2 and a capacitor C5. The transistor T7A-2 is connected between a scan output terminal OUTA2 and the first clock input terminal AIN2, and includes a gate electrode connected to a sixth node N6. The transistor T8A-2 is connected between the second node N2 and the sixth node N6 and includes a gate electrode connected to the second voltage input terminal VIN2. The transistor T9A-2 is connected between the first voltage input terminal VIN1 and the scan output terminal OUTA2 and includes a gate electrode connected to the first node N1. The capacitor C5 is connected between the sixth node N6 and the scan output terminal OUTA2.

The second buffer GWB_B2 includes transistors T7B-2, T8B-2, and T9B-2 and a capacitor C6. The transistor T7B-2 is connected between a scan output terminal OUTB2 and the second clock input terminal BIN2, and includes a gate electrode connected to a seventh node N7. The transistor T8B-2 is connected between the second node N2 and the seventh node N7, and includes a gate electrode connected to the second voltage input terminal VIN2. The transistor T9B-2 is connected between the first voltage input terminal VIN1 and the scan output terminal OUTB2, and includes a gate electrode connected to the first node N1. The capacitor C6 is connected between the seventh node N7 and the scan output terminal OUTB2.

In an embodiment, the separation of logic signal generation from clock-driven buffer activation may enable fine-grained control over scan signal timing without requiring high-voltage transitions throughout the logic circuitry. By isolating the timing-sensitive driving functions in buffers that operate at reduced voltage swing, embodiments may reduce energy usage during display refresh cycles and support a more compact and scalable scan driving solution, which may be effectively utilized in high-resolution or low-power display applications.

The first and second logic signals LS11 and LS21 output from the first logic circuit LL1 are commonly used in the first buffers GWA_A1 and GWA_A2 and the second buffers GWB_B1 and GWB_B2. For example, since the first logic circuit LL1 is commonly used in the first buffers GWA_A1 and GWA_A2 and the second buffers GWB_B1 and GWB_B2, a circuit area of the scan driving circuit 300 (see FIG. 6) may be reduced.

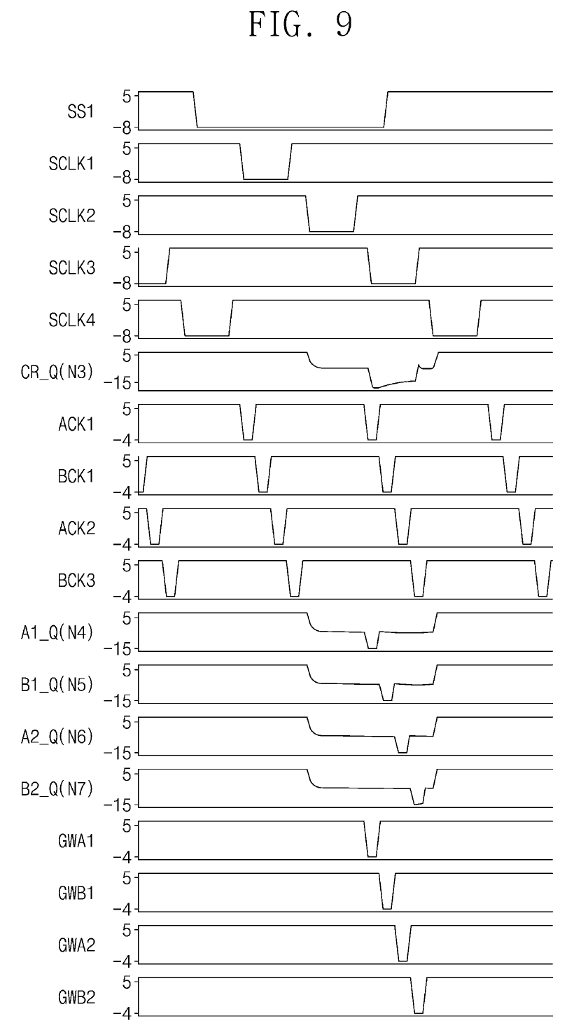

FIG. 9 is a timing diagram illustrating operations of the first logic circuit LL1, the first buffers GWA_A1 and GWA_A2, and the second buffers GWB_B1 and GWB_B2 according to an embodiment of the present disclosure.

Referring to FIGS. 8 and 9, the logic clock signals SCLK1, SCLK2, SCLK3, and SCLK4 are clock signals sequentially activated to be at a low level. A signal CR_Q indicates a voltage level of the third node N3 in the first logic circuit LL1. The second logic signal LS21 of the second node N2 may be substantially the same as the signal CR_Q.

The first clock signal ACK1, the second clock signal BCK1, the first clock signal ACK2, and the second clock signal BCK2 are clock signals sequentially activated to be at a low level.

Signals A1_Q, B1_Q, A2_Q, and B2_Q indicate voltage levels of the fourth to seventh nodes N4, N5, N6, and N7 in the first to fourth buffers GWA_A1, GWA_B1, GWA_A2, and GWA_B2, respectively.

When the logic clock signal SCLK2 is at a low level (or an active level), the transistor T1 is turned on. As the transistor T1 is turned on, the start signal SS1 in the low level is transmitted to the second node N2. Since the transistor T4 is turned on while the second node N2 is at a low level, the first node N1 is at a high level (or an inactive level) the same as the logic clock signal SCLK4. When the signal of the first node N1, that is, the first logic signal LS11 is at a high level, the transistors T2 and T6 is maintained turned off. In addition, when the first logic signal LS11 is at a high level, the transistors T9A-1, T9A-2, T9B-1, and T9-B2 may be maintained turned off.

Since the transistor T8 is turned on by the low voltage VGL, the third node N3 is at a low level, which is the same as the level of the second node N2. In this case, when the logic clock signal SCLK3 is changed from the high level to the low level, the voltage level of the third node N3 may be lowered, and the transistor T7 may be turned on. As the transistor T7 is turned on, the level of the carry signal CR1 becomes a low level, which is the same as the level of the logic clock signal SCLK3.

When the signal of the second node N2, that is, the second logic signal LS21, is at a low level, even the fourth, fifth, sixth, and seventh nodes N4, N5, N6, and N7 are also at a low level.

In this case, when the level of the logic clock signal ACK1 is changed from a high level to a low level, the voltage level of the fourth node N4 may be lowered further, and the transistor T7A-1 may be turned on. As the transistor T7A-1 is turned on, the level of the first scan signal GWA1 is shifted to a low level.

In this case, when the level of the second clock signal BCK1 is changed from the high level to the low level, the voltage level of the fifth node N5 may be lowered, and the transistor T7B-1 may be turned on. As the transistor T7B-1 is turned on, the second scan signal GWB1 is shifted to be at a low level.

In this case, when the level of the first clock signal ACK2 is changed from the high level to the low level, the voltage level of the sixth node N6 may be lowered further, and the transistor T7A-2 may be turned on. As the transistor T7A-2 is turned on, the level of the first scan signal GWA2 is changed to the low level.

In this case, when the level of the second clock signal BCK2 is changed from the high level to the low level, the voltage level of the seventh node N7 may be lowered, and the transistor T7B-2 may be turned on. As the transistor T7B-2 is turned on, the level of the second scan signal GWB2 is shifted to a low level.

As the levels of the first clock signal ACK1, the second clock signal BCK1, the first clock signal ACK2, and the second clock signal BCK2 are sequentially changed from the high level (or inactive level) to the low level (or active level), the levels of the first scan signal GWA1, the second scan signal GWB1, the first scan signal GWA2, and the second scan signal GWB2 may be sequentially changed from a high level to a low level.

As the levels of the first clock signal ACK1, the second clock signal BCK1, the first clock signal ACK2, and the second clock signal BCK2 are sequentially changed from the low level (or active level) to the high level (or inactive level), the levels of the first scan signal GWA1, the second scan signal GWB1, the first scan signal GWA2, and the second scan signal GWB2 may be sequentially changed from a low level to a high level.

When the level of the logic clock signal SCLK4 is changed from a high level to a low level, the transistor T5 is turned on. As the transistor T5 is turned on, the level of a signal of the first node N1, that is, the first logic signal LS11, becomes the low level, which is the same as the level of the low voltage VGL. When the first logic signal LS11 is in the low level (or the active level), the transistors T2 and T6 are turned on. Accordingly, the level of the carry signal CR1 becomes the high level, which is the same as the level of the high voltage VGH. The carry signal CR1 may be provided as the start signal SS1 of the second logic circuit LL2 illustrated in FIG. 7.

When the level of the first logic signal LS11 is the low level, as even the transistors T9A-1, T9A-2, T9B-1, and T9-B2 are turned on, the first scan signals GWA1 and GWA2 and the second scan signals GWB1 and GWB2 may all be maintained to be at the high level.

According to an embodiment, each of the start signal SS1 and the logic clock signals SCLK1, SCLK2, SCLK3, and SCLK4 may be a signal which swings between the high voltage VGH and the low voltage VGL.

According to an embodiment, as illustrated in FIG. 9, each of the start signal SS1 and the logic clock signals SCLK1, SCLK2, SCLK3, and SCLK4 may be a signal which swings between about 5.2 V and about -8 V.

According to an embodiment, each of the first clock signal ACK1, the second clock signal BCK1, the first clock signal ACK2, and the second clock signal BCK2 may be a signal which swings between about 5.2 V and about -4 V.

According to an embodiment, the first scan signals GWA1 and GWA2 and the second scan signals GWB1 and GWB24 may be signals having a voltage swing range from about 5.2 V to about -4 V, which is the same as a voltage swing range of the first clock signal ACK1, the second clock signal BCK1, the first clock signal ACK2, and the second clock signal BCK2.

Since the amplitudes (e.g., voltage swing width) of the first clock signal AC1, the second clock signal BCK1, the first clock signal ACK2, and the second clock signal BCK2 are smaller than the amplitudes (e.g., voltage swing width) of the logic clock signals SCLK1, SCLK2, SCLK3, and SCLK4, power consumption in the scan driving circuit 300 (see FIG. 6) may be reduced. In addition, since the amplitudes (e.g., voltage swing widths) of the first scan signals GWA1 and GWB2 and the second scan signals GWB1 and GWB2 are smaller than the amplitudes (e.g., voltage swing widths) of the logic clock signals SCLK1, SCLK2, SCLK3, and SCLK4, power consumption in the display module DM (see FIG. 3) may be reduced.

As shown in FIG. 9, in an embodiment, the ability to reduce the swing of the scan clock signals (e.g., ACK1 to BCK2) without affecting the operation of the shared logic circuit may be enabled by the separation of logic signal generation and scan signal output. The first logic circuit LL1 may output full-swing logic signals used by multiple buffers, while the buffers themselves may be driven by lower-swing clock signals that directly control the scan signal outputs. This separation of signal domains may allow for selective voltage scaling in the scan driving configuration, which may reduce both dynamic and static power consumption in the scan driving circuit 300 and the display module DM.

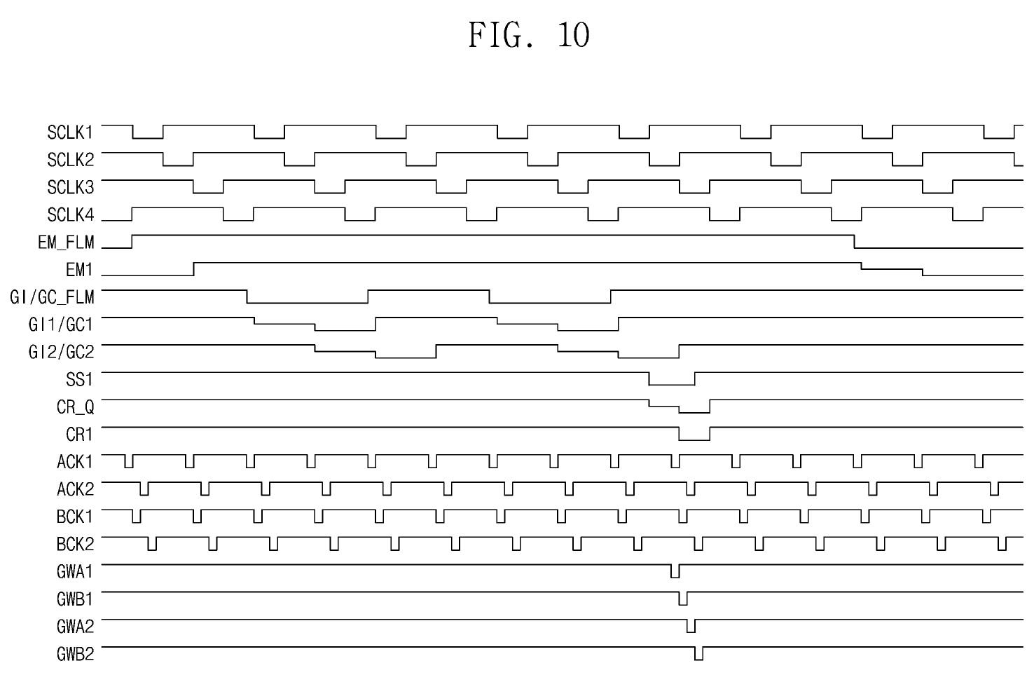

FIG. 10 is a timing diagram illustrating the operation of the scan driving circuit illustrated in FIG. 6.

Referring to FIGS. 6, 7, and 10, the logic clock signals SLK2, SCLK3, and SCLK4, and the start signal SS1 are provided to the logic circuit 331.

A light-emitting start signal EM_FLM is provided to the light-emitting driving circuit 310. The light-emitting driving circuit 310 may output the scan signal EM1 at the low level, when the level of the light-emitting start signal EM_FLM is shifted from the high level to the low level. The scan start signal GI/GC_FLM is provided to the first scan driving circuit 320. The first scan driving circuit 320 may output the scan signals GI1 and GC1 at the low level, when the scan start signal GI/GC_FLM is shifted from the high level to the low level. The first scan driving circuit 320 may output the scan signals GI2 and GC2 at the low level, after the scan signals Gl1 and GC1 are shifted to the low level. The signal CR_Q indicates a voltage level of the third node N3 in the first logic circuit LL1. The carry signal CR1 is output from the logic circuit 331.

The first clock signals ACK1 and ACK2 may be provided to the first output buffer 332. The first output buffer 332 outputs the first scan signals GWA1 and GWA2, in response to the first clock signals ACK1 and ACK2. The second clock signals BCK1 and BCK2 may be provided to the second output buffer 333. The second output buffer 333 outputs the second scan signals GWB1 and GWB2 in response to the second clock signals BCK1 and BCK2.

The logic clock signals SCLK2, SCLK3, and SCLK4, the first clock signals ACK1, ACK2, ACK3, and ACK4, the second clock signals BCK1, BCK2, BCK3, and BCK4, the start signal SS1, the light-emitting start signal EM_FLM, and the scan start signal GI/GC_FLM may be signals included in the scan control signal SCS.

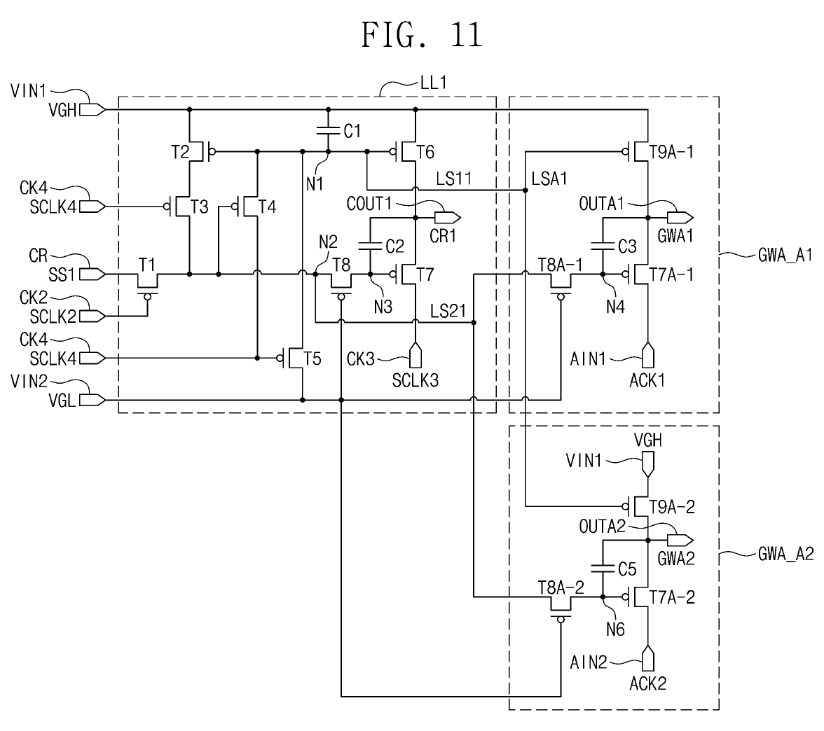

FIG. 11 is a circuit diagram of the first logic circuit LL1, the first buffer GWA_A1, and the second buffer GWA_A2 according to an embodiment of the present disclosure.

The logic circuit 331 illustrated in FIG. 6 may include the first logic circuit LL1. The first output buffer 332 illustrated in FIG. 6 may include the first buffer GWA_A1 and the first buffer GWA_A2.

According to an embodiment, the second scan driving circuit 330 does not include the second output buffer 333.

Since the first logic circuit LL1 illustrated in FIG. 11 includes the same circuit configuration as the first logic circuit LL1 illustrated in FIG. 8, the same reference numerals will be assigned to components in FIG. 11, and any redundant description will be omitted.

Since the first buffer GWA_A1 illustrated in FIG. 11 includes the same circuit configuration as the first buffer GWA_A1 illustrated in FIG. 8, the same reference numerals will be assigned to components in FIG. 11, and any redundant description will be omitted.

Since the first buffer GWA_A2 illustrated in FIG. 11 includes the same circuit configuration as the first buffer GWA_A2 illustrated in FIG. 8, the same reference numerals will be assigned to components in FIG. 11, and any redundant description will be omitted.

According to an embodiment, the first scan signal GWA1 output from the first buffer GWA_A1 and the first scan signal GWA2 output from the first buffer GWA_A2 may be provided to the first pixels disposed in mutually different rows, respectively, as illustrated in FIG. 3. For example, the first scan signal GWA1 may be provided to the first pixel PXa disposed in the first row, and the first scan signal GWA2 may be provided to the first pixel PXa disposed in the second row.

The first and second logic signals LS11 and LS21 output from the first logic circuit LL1 are commonly used in the first buffers GWA_A1 and GWA_A2. For example, since the first logic circuit LL1 is commonly used in the first buffers GWA_A1 and GWA_A2, a circuit area of the scan driving circuit 300 (see FIG. 6) may be reduced.

As is traditional in the field of the present disclosure, embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, etc., which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions.

As described above, according to the scan driving circuit having the above configuration, in embodiments of the present disclosure, one logic circuit may be commonly used for the plurality of buffers to drive the plurality of scan lines. For example, as the voltage level of the output clock signals used in the plurality of buffers is different from the voltage level of the clock signals used in the logic circuit, the power consumption of the scan driving circuit may be reduced. Accordingly, the overall power consumption of the electronic device including the scan driving circuit may be reduced.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A scan driving circuit, comprising:
a logic circuit configured to output a first logic signal and a second logic signal, in response to a start signal and a plurality of logic clock signals;
a first buffer configured to output a first scan signal, in response to a first clock signal, the first logic signal which is received from the logic circuit, and the second logic signal which is received from the logic circuit; and
a second buffer configured to output a second scan signal, in response to a second clock signal, the first logic signal which is received from the logic circuit, and the second logic signal which is received from the logic circuit,
wherein each of the first clock signal and the second clock signal has an amplitude smaller than an amplitude of each of the logic clock signals, and
wherein the logic circuit is commonly connected to the first buffer and the second buffer.

2. The scan driving circuit of claim 1, wherein the first buffer includes:
a first transistor connected between a first voltage input terminal and a scan output terminal and configured to output the first scan signal,
wherein the first transistor includes a gate electrode and is configured to receive the first logic signal;
a second transistor connected between a first node and a second node,
wherein the second transistor includes a gate electrode connected to a second voltage input terminal;
a third transistor connected between the scan output terminal and a clock input terminal and configured to receive the first scan signal,
wherein the third transistor includes a gate electrode connected to the second node; and
a capacitor connected between the second node and the scan output terminal.

3. The scan driving circuit of claim 1, wherein the second buffer includes:
a first transistor connected between a first voltage input terminal and a scan output terminal and configured to output the second scan signal,
wherein the first transistor includes a gate electrode and is configured to receive the first logic signal;
a second transistor connected between a first node and a second node,
wherein the second transistor includes a gate electrode connected to a second voltage input terminal;
a third transistor connected between the scan output terminal and a clock input terminal and configured to receive the second scan signal,
wherein the third transistor includes a gate electrode connected to the second node; and
a capacitor connected between the second node and the scan output terminal.

4. The scan driving circuit of claim 1, wherein the first scan signal and the second scan signal are sequentially changed from an inactive level to an active level, when the first clock signal and the second clock signal are sequentially changed from the inactive level to the active level.

5. The scan driving circuit of claim 1, wherein the first buffer outputs the first scan signal corresponding to the first clock signal, when the second logic signal is at an active level, and
wherein the second buffer outputs the second scan signal corresponding to the second clock signal, when the second logic signal is at the active level.

6. The scan driving circuit of claim 1, wherein the first buffer outputs the first scan signal at an inactive level, when the first logic signal is at an active level, and
wherein the second buffer outputs the second scan signal at the inactive level, when the first logic signal is at the active level.

7. The scan driving circuit of claim 1, further comprising:
a third buffer configured to output a third scan signal, in response to a third clock signal, the first logic signal, and the second logic signal; and
a fourth buffer configured to output a fourth scan signal, in response to a fourth clock signal, the first logic signal, and the second logic signal.

8. The scan driving circuit of claim 7, wherein the first scan signal, the second scan signal, the third scan signal, and the fourth scan signal are sequentially changed from an inactive level to an active level, when the first clock signal, the second clock signal, the third clock signal, and the fourth clock signal are sequentially changed from the inactive level to the active level.

9. An electronic device, comprising:
a display panel including a first pixel and a second pixel; and
a scan driving circuit configured to provide a first scan signal to the first pixel and a second scan signal to the second pixel, in response to a start signal, a plurality of logic clock signals, a first clock signal, and a second clock signal,
wherein the scan driving circuit includes:
a logic circuit configured to output a first logic signal and a second logic signal, in response to the start signal and the logic clock signals;
a first buffer configured to output the first scan signal, in response to the first clock signal, the first logic signal which is received from the logic circuit, and the second logic signal which is received from the logic circuit; and
a second buffer configured to output the second scan signal, in response to the second clock signal, the first logic signal which is received from the logic circuit, and the second logic signal which is received from the logic circuit,
wherein each of the first clock signal and the second clock signal has an amplitude smaller than an amplitude of each of the logic clock signals, and
wherein the logic circuit is commonly connected to the first buffer and the second buffer.

10. The electronic device of claim 9, wherein the first buffer includes:
a first transistor connected between a first voltage input terminal and a scan output terminal and configured to output the first scan signal,
wherein the first transistor includes a gate electrode and is configured to receive the first logic signal;
a second transistor connected between a first node and a second node,
wherein the second transistor includes a gate electrode connected to a second voltage input terminal;
a third transistor connected between the scan output terminal and a clock input terminal and configured to receive the first scan signal,
wherein the third transistor includes a gate electrode connected to the second node; and
a capacitor connected between the second node and the scan output terminal.

11. The electronic device of claim 9, wherein the second buffer includes:
a first transistor connected between a first voltage input terminal and a scan output terminal and configured to output the second scan signal,
wherein the first transistor includes a gate electrode and is configured to receive the first logic signal;
a second transistor connected between a first node and a second node,
wherein the second transistor includes a gate electrode connected to a second voltage input terminal;
a third transistor connected between the scan output terminal and a second clock input terminal and configured to receive the second scan signal,
wherein the third transistor includes a gate electrode connected to the second node; and
a capacitor connected between the second node and the scan output terminal.

12. The electronic device of claim 9, further comprising:
a driving controller configured to provide the start signal, the logic clock signals, the first clock signal, and the second clock signal.

13. The electronic device of claim 12, wherein the first scan signal and the second scan signal are sequentially changed from an inactive level to an active level, when the first clock signal and the second clock signal are sequentially changed from the inactive level to the active level.

14. The electronic device of claim 9, wherein the first buffer outputs the first scan signal corresponding to the first clock signal, when the second logic signal is at an active level, and
wherein the second buffer outputs the second scan signal corresponding to the second clock signal, when the second logic signal is at the active level.

15. The electronic device of claim 9, wherein the first buffer outputs the first scan signal at an inactive level, when the first logic signal is at an active level, and
wherein the second buffer outputs the second scan signal at the inactive level, when the first logic signal is at the active level.

16. The electronic device of claim 9, wherein a data line is commonly connected to the first pixel and the second pixel, and
wherein the first scan signal and the second scan signal are sequentially changed from an inactive level to an active level.

17. The electronic device of claim 16, wherein the first pixel and the second pixel are sequentially disposed in a first row.

18. The electronic device of claim 17, wherein the display panel further includes:
a third pixel and a fourth pixel disposed in a second row,
wherein the scan driving circuit further includes:
a third buffer configured to output a third scan signal, in response to a third clock signal, the first logic signal, and the second logic signal; and
a fourth buffer configured to output a fourth scan signal, in response to a fourth clock signal, the first logic signal, and the second logic signal.

19. An electronic device, comprising:
a processor configured to output an image signal and a control signal; and
a display module configured to display an image, in response to the image signal and the control signal,
wherein the display module includes:
a display panel including a first pixel and a second pixel;
a driving controller configured to output a scan control signal, in response to the image signal and the control signal; and
a scan driving circuit configured to provide a first scan signal to the first pixel and a second scan signal to the second pixel,
wherein the scan control signal includes a start signal, a plurality of logic clock signals, a first clock signal, and a second clock signal,
wherein the scan driving circuit includes:
a logic circuit configured to output a first logic signal and a second logic signal, in response to the start signal and the logic clock signals;
a first buffer configured to output the first scan signal, in response to the first clock signal, the first logic signal which is received from the logic circuit, and the second logic signal which is received from the logic circuit; and
a second buffer configured to output the second scan signal, in response to the second clock signal, the first logic signal which is received from the logic circuit, and the second logic signal which is received from the logic circuit,
wherein each of the first clock signal and the second clock signal has an amplitude smaller than an amplitude of each of the logic clock signals, and
wherein the logic circuit is commonly connected to the first buffer and the second buffer.

20. The electronic device of claim 19, wherein the first scan signal and the second scan signal are sequentially changed from an inactive level to an active level, when the first clock signal and the second clock signal are sequentially changed from the inactive level to the active level.
